(19) United States
(12) Patent Application Publication
(10) Pub. No.: US 2026/0255346 A1
(43) Pub. Date: Aug. 27, 2026

(54) TECHNIQUES FOR SCHEDULING DOWNLINK DATA TRANSMISSIONS

(71) Applicant: QUALCOMM Incorporated, San Diego, CA (US)

(72) Inventors: Diana MAAMARI, San Diego, CA (US); Gabi SARKIS, San Diego, CA (US); Gokul SRIDHARAN, Sunnyvale, CA (US)

(21) Appl. No.: 19/065,956

(22) Filed: Feb. 27, 2025

(51) Int. Cl. H04W 72/1273; H04W 24/02; H04W 72/0446

(52) U.S. Cl. CPC H04W 72/1273; H04W 24/02; H04W 72/0446

(57) ABSTRACT

Methods, systems, and devices for wireless communications are described. In some examples, a user equipment (UE) may transmit capability information that indicates a quantity of slots the UE is capable of being scheduled for downlink data transmissions within a time window while the UE is operating in a reduced processing operational state. The reduced processing operational state being associated with a first downlink data processing timeline that is different from a second downlink data processing timeline for a second processing operational state. The UE may receive one or more control messages to schedule one or more data transmissions in up to the quantity of slots within a first time window in accordance with the capability information. The UE may receive the one or more data transmissions within the first time window in accordance with the one or more control messages.

### FIELD OF TECHNOLOGY

The following relates to wireless communications, including techniques for scheduling downlink data transmissions.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a network entity is described. The method may include obtaining, from a user equipment (UE), capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state, outputting, to the UE, one or more control messages to schedule one or more data transmissions in up to the quantity of slots within a first time window in accordance with the capability information, and outputting the one or more data transmissions within the first time window in accordance with the one or more control messages.

A network entity for wireless communication is described. The network entity may include one or more memories storing processor executable code, and one or more processors coupled with the one or more memories. The one or more processors may individually or collectively be operable to execute the code to cause the network entity to obtain, from a UE, capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state, output, to the UE, one or more control messages to schedule one or more data transmissions in up to the quantity of slots within a first time window in accordance with the capability information, and output the one or more data transmissions within the first time window in accordance with the one or more control messages.

Another network entity for wireless communication is described. The network entity may include means for obtaining, from a UE, capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state, means for outputting, to the UE, one or more control messages to schedule one or more data transmissions in up to the quantity of slots within a first time window in accordance with the capability information, and means for outputting the one or more data transmissions within the first time window in accordance with the one or more control messages.

A non-transitory computer-readable medium storing code for wireless communication is described. The code may include instructions executable by one or more processors to obtain, from a UE, capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state, output, to the UE, one or more control messages to schedule one or more data transmissions in up to the quantity of slots within a first time window in accordance with the capability information, and output the one or more data transmissions within the first time window in accordance with the one or more control messages.

In some examples of the method, network entities, and non-transitory computer-readable medium described herein, outputting the one or more control messages may include operations, features, means, or instructions for outputting a first control message scheduling a first data transmission in a first slot within the first time window, where the first time window includes a first quantity of soft gap slots and a first quantity of hard gap slots, where the one or more data transmissions may be not scheduled in the hard gap slots, and where the one or more data transmissions may be scheduled in one or more of the soft gap slots.

In some examples of the method, network entities, and non-transitory computer-readable medium described herein, the first quantity of soft gaps slots may be equal to the quantity of slots the UE may be capable of being scheduled for downlink data transmissions less one.

In some examples of the method, network entities, and non-transitory computer-readable medium described herein, outputting the one or more control messages may include operations, features, means, or instructions for outputting a second control message scheduling a second data transmission in a second slot within a second time window, where an overlapping portion of the first time window and the second time window includes a second quantity of soft gap slots and a second quantity of hard gap slots, where the first quantity of soft gaps slots may be equal to the quantity of slots the UE may be capable of being scheduled for downlink data transmissions less two.

Some examples of the method, network entities, and non-transitory computer-readable medium described herein may further include operations, features, means, or instructions for obtaining an indication of the second quantity of soft gap slots, the second quantity of hard gap slots, or both.

In some examples of the method, network entities, and non-transitory computer-readable medium described herein, the quantity of slots the UE may be capable of being scheduled for downlink data transmissions equals a quantity of simultaneous active data transmissions the UE may be capable of being scheduled within the time window while operating in the reduced processing operational state.

In some examples of the method, network entities, and non-transitory computer-readable medium described herein, outputting the one or more control messages may include operations, features, means, or instructions for outputting a first control message scheduling a first data transmission in a first slot within the first time window, where an active count may be incremented by one for a duration associated with an active data transmission, and where the active count may be decremented by one after the duration.

In some examples of the method, network entities, and non-transitory computer-readable medium described herein, outputting the one or more control messages may include operations, features, means, or instructions for outputting a second control message scheduling a second data transmission in a second slot within the first time window, where the active count may be incremented by one for the duration associated with the active data transmission, where the active count may be decremented by one after the duration.

Some examples of the method, network entities, and non-transitory computer-readable medium described herein may further include operations, features, means, or instructions for obtaining an indication of the active count.

In some examples of the method, network entities, and non-transitory computer-readable medium described herein, outputting the one or more control messages may include operations, features, means, or instructions for outputting a first control message scheduling a first data transmission in a first slot within the first time window, where an active count may be incremented by an amount associated with an amount of time resources or frequency resources of the first slot scheduled with the first data transmission.

In some examples of the method, network entities, and non-transitory computer-readable medium described herein, the quantity of slots the UE may be capable of being scheduled for downlink data transmissions within the time window may be based on a quantity of resource elements.

In some examples of the method, network entities, and non-transitory computer-readable medium described herein, obtaining the capability information may include operations, features, means, or instructions for obtaining an indication of a duration associated with an active data transmission.

A method for wireless communication by a UE is described. The method may include transmitting capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state, receiving one or more control messages to schedule one or more data transmissions in up to the quantity of slots within a first time window in accordance with the capability information, and receiving the one or more data transmissions within the first time window in accordance with the one or more control messages.

A UE for wireless communication is described. The UE may include one or more memories storing processor executable code, and one or more processors coupled with the one or more memories. The one or more processors may individually or collectively be operable to execute the code to cause the UE to transmit capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state, receive one or more control messages to schedule one or more data transmissions in up to the quantity of slots within a first time window in accordance with the capability information, and receive the one or more data transmissions within the first time window in accordance with the one or more control messages.

Another UE for wireless communication is described. The UE may include means for transmitting capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state, means for receiving one or more control messages to schedule one or more data transmissions in up to the quantity of slots within a first time window in accordance with the capability information, and means for receiving the one or more data transmissions within the first time window in accordance with the one or more control messages.

A non-transitory computer-readable medium storing code for wireless communication is described. The code may include instructions executable by one or more processors to transmit capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state, receive one or more control messages to schedule one or more data transmissions in up to the quantity of slots within a first time window in accordance with the capability information, and receive the one or more data transmissions within the first time window in accordance with the one or more control messages.

In some examples of the method, user equipment (UEs), and non-transitory computer-readable medium described herein, receiving the one or more control messages may include operations, features, means, or instructions for receiving a first control message scheduling a first data transmission in a first slot within the first time window, where the first time window includes a first quantity of soft gap slots and a first quantity of hard gap slots, where the one or more data transmissions may be not scheduled in the hard gap slots, and where the one or more data transmissions may be scheduled in one or more of the soft gap slots.

In some examples of the method, user equipment (UEs), and non-transitory computer-readable medium described herein, the first quantity of soft gaps slots may be equal to the quantity of slots the UE may be capable of being scheduled for downlink data transmissions less one.

In some examples of the method, user equipment (UEs), and non-transitory computer-readable medium described herein, receiving the one or more control messages may include operations, features, means, or instructions for receiving a second control message scheduling a second data transmission in a second slot within a second time window, where an overlapping portion of the first time window and the second time window includes a second quantity of soft gap slots and a second quantity of hard gap slots, where the first quantity of soft gaps slots may be equal to the quantity of slots the UE may be capable of being scheduled for downlink data transmissions less two.

Some examples of the method, user equipment (UEs), and non-transitory computer-readable medium described herein may further include operations, features, means, or instructions for transmitting an indication of the second quantity of soft gap slots, the second quantity of hard gap slots, or both.

In some examples of the method, user equipment (UEs), and non-transitory computer-readable medium described herein, the quantity of slots the UE may be capable of being scheduled for downlink data transmissions equals a quantity of simultaneous active data transmissions the UE may be capable of being scheduled within the time window while operating in the reduced processing operational state.

In some examples of the method, user equipment (UEs), and non-transitory computer-readable medium described herein, receiving the one or more control messages may include operations, features, means, or instructions for receiving a first control message scheduling a first data transmission in a first slot within the first time window, where an active count may be incremented by one for a duration associated with an active data transmission, and where the active count may be decremented by one after the duration.

In some examples of the method, user equipment (UEs), and non-transitory computer-readable medium described herein, receiving the one or more control messages may include operations, features, means, or instructions for receiving a second control message scheduling a second data transmission in a second slot within the first time window, where the active count may be incremented by one for the duration associated with the active data transmission, where the active count may be decremented by one after the duration.

Some examples of the method, user equipment (UEs), and non-transitory computer-readable medium described herein may further include operations, features, means, or instructions for transmitting an indication of the active count.

In some examples of the method, user equipment (UEs), and non-transitory computer-readable medium described herein, receiving the one or more control messages may include operations, features, means, or instructions for receiving a first control message scheduling a first data transmission in a first slot within the first time window, where an active count may be incremented by an amount associated with an amount of time resources or frequency resources of the first slot scheduled with the first data transmission.

In some examples of the method, user equipment (UEs), and non-transitory computer-readable medium described herein, the quantity of slots the UE may be capable of being scheduled for downlink data transmissions within the time window may be based on a quantity of resource elements.

In some examples of the method, user equipment (UEs), and non-transitory computer-readable medium described herein, transmitting the capability information may include operations, features, means, or instructions for transmitting an indication of a duration associated with an active data transmission.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for scheduling downlink data transmissions in accordance with one or more aspects of the present disclosure.

FIG. 2 shows an example of a wireless communications system that supports techniques for scheduling downlink data transmissions in accordance with one or more aspects of the present disclosure.

FIG. 3 shows examples of resource diagrams that supports techniques for scheduling downlink data transmissions in accordance with one or more aspects of the present disclosure.

FIG. 4 shows examples of resource diagrams that supports techniques for scheduling downlink data transmissions in accordance with one or more aspects of the present disclosure.

FIG. 5 shows examples of resource diagrams that supports techniques for scheduling downlink data transmissions in accordance with one or more aspects of the present disclosure.

FIG. 6 shows an example of a process flow that supports techniques for scheduling downlink data transmissions in accordance with one or more aspects of the present disclosure.

FIGS. 7 and 8 show block diagrams of devices that support techniques for scheduling downlink data transmissions in accordance with one or more aspects of the present disclosure.

FIG. 9 shows a block diagram of a communications manager that supports techniques for scheduling downlink data transmissions in accordance with one or more aspects of the present disclosure.

FIG. 10 shows a diagram of a system including a device that supports techniques for scheduling downlink data transmissions in accordance with one or more aspects of the present disclosure.

FIGS. 11 and 12 show block diagrams of devices that support techniques for scheduling downlink data transmissions in accordance with one or more aspects of the present disclosure.

FIG. 13 shows a block diagram of a communications manager that supports techniques for scheduling downlink data transmissions in accordance with one or more aspects of the present disclosure.

FIG. 14 shows a diagram of a system including a device that supports techniques for scheduling downlink data transmissions in accordance with one or more aspects of the present disclosure.

FIGS. 15 and 16 show flowcharts illustrating methods that support techniques for scheduling downlink data transmissions in accordance with one or more aspects of the present disclosure.

### DETAILED DESCRIPTION

In some wireless communications systems, a user equipment (UE) may be configured to receive downlink data transmissions at a reduced peak throughput. For example, a network entity in communication with the UE may indicate to the UE that downlink scheduling of data transmissions is in accordance with the reduced peak throughput. In some cases, the network entity may not schedule the UE for a quantity of slots (e.g., gap slots) following a slot in which a wideband downlink data transmission is received to allow the UE to process the wideband downlink data transmission at a low baseband processing state. During the gap slots, the UE may enter a relatively high power state to process the downlink data transmission received. The UE may include a buffer for storing received data of the downlink data transmissions, and the gap slots are used to allow the data to be read from the buffer before the next slot is written to the buffer. In some cases, the buffer size may fit more than one slot of downlink data transmission, and the more than one slot of data may be received before the gap slots are used. However, an agreement between the UE and the network entity scheduling the downlink data transmissions may not be signaled and the buffer may overflow or the buffer may not be efficiently utilized, resulting in lack of coordination and wasted energy or processing power.

Techniques for scheduling downlink data transmissions may be employed. In some examples, the UE may be scheduled with a quantity of data transmissions within a time window based on UE capacity to avoid overflowing of the buffer. For example, the UE may transmit, to a network entity, capability information that indicates a quantity of slots the UE is capable of being scheduled for downlink data transmissions within a time window while the UE is operating in a reduced processing operational state. The reduced processing operational state may be associated with a first downlink data processing timeline that is different from a second downlink data processing timeline for a second processing operational state. The UE may receive, from the network entity, control messages to schedule data transmissions in up to the quantity of slots within a first time window in accordance with the capability information. The UE may receive, from the network entity, the data transmissions in accordance with the one or more control messages.

Aspects of the disclosure are initially described in the context of wireless communications systems. Aspects of the disclosure are further illustrated by and described with reference to resource diagrams, a process flow, apparatus diagrams, system diagrams, and flowcharts that relate to techniques for scheduling downlink data transmissions.

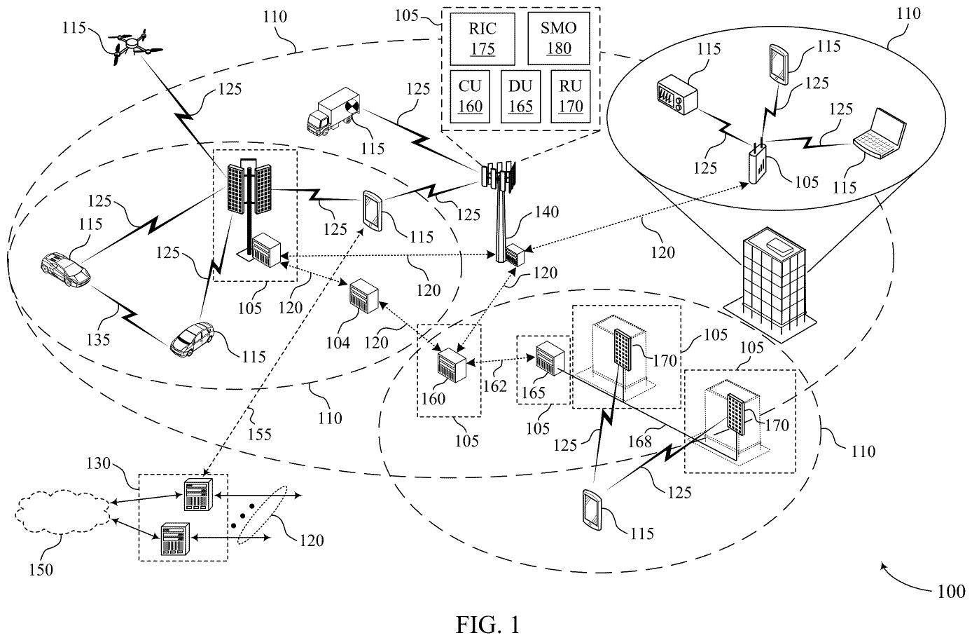

FIG. 1 shows an example of a wireless communications system 100 that supports techniques for scheduling downlink data transmissions in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for scheduling downlink data transmissions as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems 100, a UE 115 may be configured for energy efficient scheduling. The UE 115 may be configured to receive downlink data transmissions at a reduced peak throughput. For example, a network entity 105 in communication with the UE 115 may indicate to the UE 115 that downlink scheduling of data transmissions is in accordance with a reduced peak throughput or that a quantity of slots following a first slot in which a downlink data transmission is received are gap slots not to be scheduled with downlink data transmissions. For example, the reduced peak throughput may be achieved by guaranteeing that the UE 115 does not receive any scheduling following a wideband physical downlink shared channel (PDSCH) transmission, and the UE may have relaxed feedback for the wideband PDSCH transmission. The efficient energy scheduling may be a scaling in time, and the UE 115 may be configured with a duty cycle where the UE 115 does not expect any PDSCH transmissions or downlink data transmissions for X slots following a wideband PDSCH transmission. The reduced throughput allows for decoupling radio frequency (RF), and the baseband power state enables a reduction in UE energy. When downlink data is less than peak throughput, gaps are guaranteed between PDSCH transmissions, and the feedback timeline is relaxed (e.g., the UE has a longer amount of time to provide feedback). The UE 115 may move RF to a high-power state but keep baseband in a lower-power state. During the gap slots, the UE 115 may enter a relatively high power state to process the PUSCH transmission received.

In some examples, the UE 115 may be configured to perform RF operations, baseband operations, or both. For high throughput and wideband scheduling, the UE 115 may enter a higher power state. In new radio (NR) wireless communications systems, the UE 115 may move its internal baseband clock/voltage to higher power state when the UE 115 switches to wideband scheduling. This high-power mode of the UE 115 involves higher clock frequency and generally higher supply voltage to support the higher clock frequency, leading to a quadratic increase in power consumption as well as leakage.

In some cases, the network entity 105 may inform the UE 115 as to how long the UE 115 will be scheduled with wideband scheduling such that the UE 115 may set its clock frequency and voltage based on the wideband scheduling and not necessitate the highest setting corresponding to the wideband scheduling for longer than is used. The UE 115 may benefit from an indication that the UE 115 will not be scheduled with sustained peak throughput. For example, the network entity 105 may guarantee the UE 115 that there will be no scheduling of PDSCH transmissions following a wideband scheduling.

In some cases, the network entity 105 may guarantee (e.g., signal) to the UE 115: that a maximum scheduled throughput may not exceed a limit; that a feedback timeline may be relaxed; if feedback occasion is kept the same as with narrowband scheduling, that the broadband may be kept at low; that there will be gaps (e.g., scheduling gaps) between PDSCH transmissions, or any combination thereof.

In some examples, the UE 115 may include a receiver fast Fourier transform (RxFFT) buffer that stores received PDSCH transmissions. Scheduling gaps may be between PDSCH transmissions such that all data has been read from the buffer before the next symbol is to be written to the buffer. The buffer size may impact efficient scheduling (e.g., when the UE operates in the reduced processing operational state). With efficient scheduling, the UE 115 is not expected to be scheduled with “N” slots following the wideband PDSCH transmission since the UE 115 uses the duration of the “N” slots to process the wideband PDSCH transmission at the low baseband (BB) state. In some cases, a time domain (TD) or frequency domain (FD) buffer size may fit more than one slot worth of samples. For example, the buffer may hold multiple slots corresponding to multiple PDSCH transmissions. Due to the buffer size, the UE 115 may receive multiple PDSCH transmissions before a scheduling gap. For example, two PDSCH transmission may be received before the scheduling gaps are used for BB processing. In some cases, the two PDSCH transmissions may not be scheduled back-to-back. However, the UE 115 and the network entity 105 may fail to coordinate scheduling the PDSCH transmissions or downlink data transmissions considering the buffer size of the UE 115, and the buffer may overflow or the buffer may not be efficiently utilized, resulting in lack of coordination and wasted energy and/or processing power.

Techniques for scheduling downlink data transmissions may be employed. In some examples, the UE may be scheduled with a quantity of data transmissions within a time window based on UE capacity to avoid overflowing of the buffer. For example, the UE may transmit, to a network entity, capability information that indicates a quantity of slots the UE is capable of being scheduled for downlink data transmissions within a time window while the UE is operating in a reduced processing operational state. The reduced processing operational state being associated with a first downlink data processing timeline that is different from a second downlink data processing timeline for a second processing operational state. The UE may receive, from the network entity, control messages to schedule data transmissions in up to the quantity of slots within a first time window in accordance with the capability information. The UE may receive, from the network entity, the data transmissions in accordance with the one or more control messages.

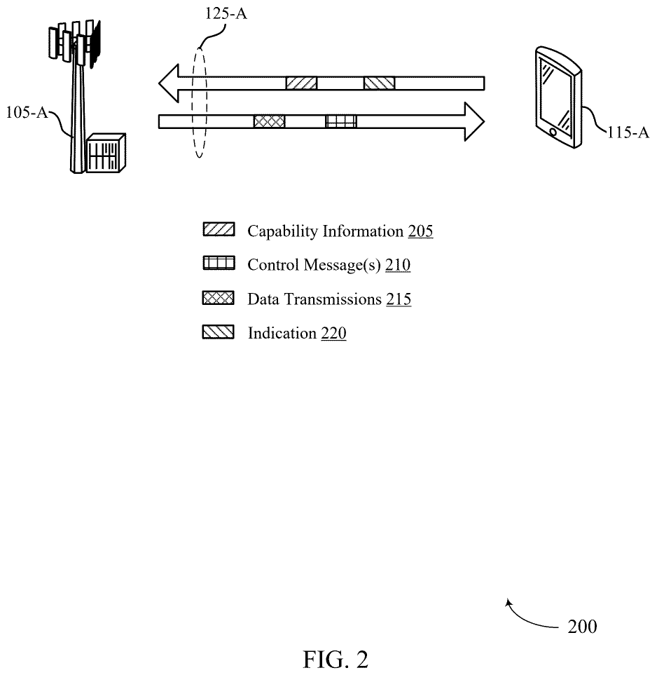

FIG. 2 shows an example of a wireless communications system 200 that supports techniques for scheduling downlink data transmissions in accordance with one or more aspects of the present disclosure. The wireless communications system 200 may implement or may be implemented by aspects of the wireless communications system 100. For example, the wireless communications system 200 may include a UE 115-a, which may be an example of a UE 115 as described herein. The wireless communications system 200 may include a network entity 105-a, which may be an example of a network entity 105 as described herein.

In some examples, the UE 115-a may communicate with the network entity 105-a using a communication link 125-a. The communication link 125-a may be an example of a 6th generation (6G), a NR or LTE link between the UE 115-a and the network entity 105-a. The communication link 125-a may include a bi-directional link that enable both uplink and downlink communications. For example, the UE 115-a may transmit uplink signals (e.g., uplink transmissions), such as uplink reference signals, uplink control signals or uplink data signals, to the network entity 105-a using the communication link 125-a and the network entity 105-a may transmit downlink signals (e.g., downlink transmissions), such as downlink reference signals, downlink control signals or downlink data signals, to the UE 115-a using the communication link 125-a.

In some examples, the UE 115-a may be configured for energy efficient scheduling. The UE 115-a may be configured to receive downlink data transmissions at a reduced peak throughput. For the energy efficient scheduling, the UE 115-a may be configured to operate in a reduced processing operational state. For example, the reduced processing operational state may be associated with a first downlink data processing timeline that is longer than a second downlink data processing timeline for a second processing operational state. The reduced processing operational state may permit the UE 115-a to remain in a lower power state while decoding one or more downlink data transmissions and the first downlink data processing timeline may allot the UE 115-a more time to provide feedback indicating whether decoding of the one or more downlink data transmissions was successful (as compared to the second processing operational state that may consume more power and may have a shorter time window within which to provide feedback). For the reduced processing operational state, downlink scheduling of data transmissions is in accordance with a reduced peak throughput or that a quantity of slots following a first slot in which a downlink data transmission is received may be gap slots not to be scheduled with downlink data transmissions. For example, the reduced processing operational state may be achieved by providing (e.g., guaranteeing) that the UE 115-a receive reduced scheduling following a wideband PDSCH transmission, and the UE 115-a may have a relaxed timeline for providing feedback for the wideband PDSCH transmission. In some cases, the buffer of the UE 115-a may fit more than one slot of samples, and multiple PDSCHs may be received before the gaps are used for BB processing. For example, the UE 115-a may be scheduled with at most X PDSCH transmissions where Y slots are used for BB processing for each of the PDSCH transmissions, and a limitation of how many PDSCH transmissions or how many samples may be scheduled in time window may be based on UE capability to avoid overflowing the FD or TD buffer which is different than setting the limits based on the log likelihood ratios (LLRs).

In some examples, the UE 115-a may transmit, to the network entity 105-a, capability information 205 that indicates a quantity of slots the UE is capable of being scheduled for downlink data transmissions or PDSCH transmissions within a time window while the UE 115-a is operating in the reduced processing operational state. The UE 115-a may receive, from the network entity 105-a, control message(s) 210 to schedule data transmissions in up to the quality of slots within a first time window according to the capability information. The UE 115-a may receive, from the network entity 105-a, data transmission(s) 215 within the first time window in accordance with the control message(s) 210.

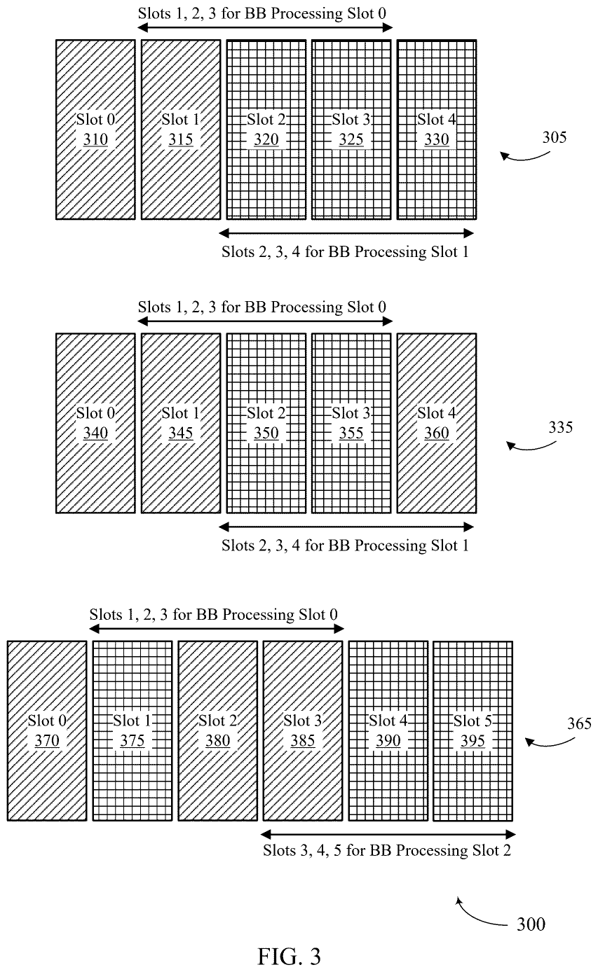

FIG. 3 shows examples of resource diagrams 300 that supports techniques for scheduling downlink data transmissions in accordance with one or more aspects of the present disclosure. The resource diagrams 300 illustrates example cases for a buffer of the UE 115-a that stores two PDSCH transmissions. The resource diagrams 300 may implement or be implemented by one or more aspects described with reference to FIGS. 1 and 2. For example, the UE 115-a may transmit, to the network entity 105-a, capability information 205 that indicates a quantity of two slots that the UE is capable of being scheduled for PDSCH transmissions within a time window of four slots while the UE 115-a is operating in the reduced processing operational state. The network entity 105-a may transmit, to the UE 115-a, control messages to schedule PDSCH transmissions in the slots of the resource diagrams 300.

A resource diagram 305 illustrates an acceptable scheduling case with no more than two active PDSCH overlapping. A PDSCH transmission may be scheduled in slot 0 310. The PDSCH transmission associated with slot 0 310 may be active or may be BB processed in a duration corresponding to slot 1 315, slot 2 320, and slot 3 325. A PDSCH transmission may be scheduled in slot 1 315. The PDSCH transmission associated with slot 1 315 may be active or may be BB processed in a duration corresponding to slot 2 320, slot 3 325, and slot 4 330. In the resource diagram 305, slot 2 320, slot 3 325, and slot 4, 330 are gap slots that are not scheduled with PDSCH transmissions. For the resource diagram 305, the two active PDSCH overlap and may be BB processed without overflow of the buffer of the UE 115-a.

A resource diagram 335 illustrates another acceptable scheduling case with no more than two active PDSCH overlapping. A PDSCH transmission may be scheduled in slot 0 340. The PDSCH transmission associated with slot 0 340 may be active or may be BB processed in a duration corresponding to slot 1 345, slot 2 350, and slot 3 355. A PDSCH transmission may be scheduled in slot 1 345. The PDSCH transmission associated with slot 1 345 may be active or may be BB processed in a duration corresponding to slot 2 350, slot 3 355, and slot 4 360. In the resource diagram 335, slot 2 350 and slot 3 355 are gap slots that are not scheduled with PDSCH transmissions. A PDSCH transmission may be scheduled in slot 4 360 because the buffer of the UE 115-a may store two PDSCH transmissions, and the PDSCH transmission associated with slot 0 340 has been BB processed and is no longer active for slot 4 360.

A resource diagram 365 illustrates an error case with more than two active PDSCH overlapping resulting an overflow of the buffer of the UE 115-a. A PDSCH transmission may be scheduled in slot 0 370, and slot 1 375 may be a gap slot. The PDSCH transmission associated with slot 0 370 may be active or may be BB processed in a duration corresponding to slot 1 375, slot 2 380, and slot 3 385. A PDSCH transmission may be scheduled in slot 2 380. The PDSCH transmission associated with slot 2 380 may be active or may be BB processed in a duration corresponding to slot 3 385, slot 4 390, and slot 5 395. A PDSCH transmission scheduled in slot 3 385 provides three overlapping PDSCH transmissions or three active PDSCH transmissions. The three active PDSCH transmission is an error case because the buffer of the UE 115-a may store up to two PDSCH transmissions. Slot 4 390 and slot 5 395 may be gap slots. Slot 3 385 should not have been scheduled since two active PDSCH transmissions were already scheduled within the time window. The buffer size may not accommodate for the extra samples when RF is running at a lower clock.

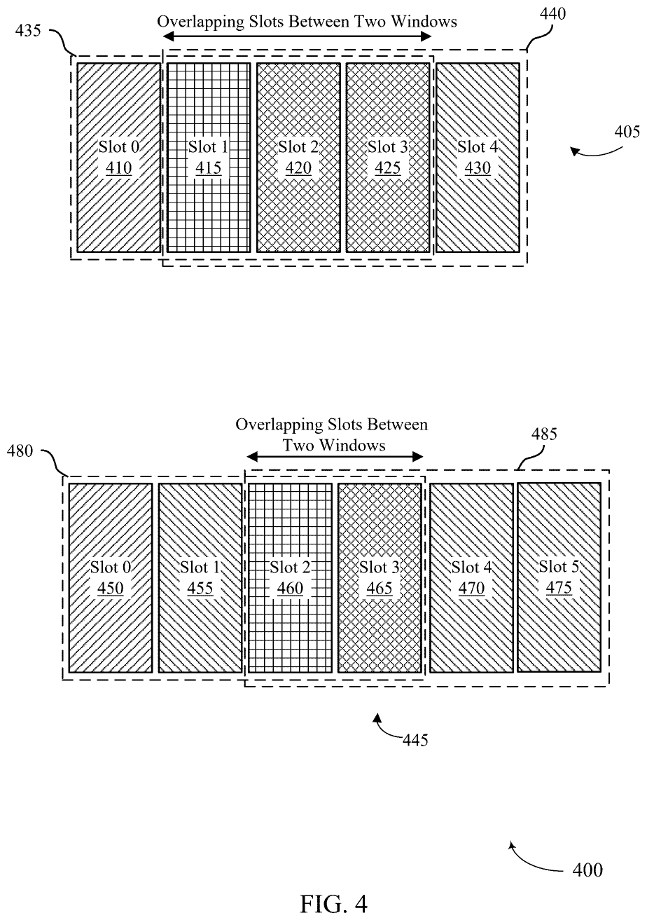

FIG. 4 shows examples of resource diagrams 400 that supports techniques for scheduling downlink data transmissions in accordance with one or more aspects of the present disclosure. The resource diagrams 400 illustrate example cases for the UE 115-a that may be scheduled with X PDSCH transmissions where Y slots are used for BB processing for each of the X PDSCH transmissions. The resource diagrams 400 may implement or be implemented by one or more aspects described with reference to FIGS. 1 and 2. For example, the UE 115-a may transmit, to the network entity 105-a, capability information 205 that indicates a quantity of slots that the UE is capable of being scheduled for PDSCH transmissions within a time window while the UE 115-a is operating in the reduced processing operational state. The network entity 105-a may transmit, to the UE 115-a, control messages to schedule PDSCH transmissions in the slots of the resource diagrams 400.

In the limited through put mode with a relaxed feedback timeline (e.g., efficient scheduling permitting the UE 115-a to operate in the reduced processing operational state), for a scheduled PDSCH transmission, the UE 115-a may be configured with a sliding widow of size N slots, where N−1 slots immediately after a scheduled PDSCH are either soft gap slots or hard gap slots. A type 1 hard gap slot is a slot where the UE 115-a may not be scheduled with a PDSCH transmission. A type 2 soft gap slot is a slot where the UE 115-a may be scheduled with a PDSCH transmission following a first scheduled PDSCH transmission, and the soft gap slot may be used for BB processing of the first PDSCH transmission.

For a resource diagram 405, a PDSCH transmission may be scheduled in slot 0 410 and slot 1 415, slot 2 420, and slot 3 425 may be used for BB processing of the PDSCH transmission scheduled in slot 0 410. A window 435 may be associated with the PDSCH transmission scheduled in slot 0 410 and processed in slot 1 415, slot 2 420, and slot 3 425. For the case where the buffer may store two PDSCH transmissions, slot 1 415 may be a soft gap slot that is scheduled with a second PDSCH transmission, and the second PDSCH transmission may be BB processed in slot 2 420, slot 3 425, and slot 4 430. A window 440 may be associated with the PDSCH transmission scheduled in slot 1 415 and processed in slot 2 420, slot 3 425, and slot 4 430. The UE does not expect more than x soft gaps in overlapped slots of scheduling windows, the remaining overlapped slots are hard gap slot that the UE 115-a may not be scheduled with PDSCH transmission. For the example where the UE 115-a may be scheduled with two PDSCH transmissions with the time window, the value of x may be one (e.g., two minus one). Any gap slot may be considered as a soft gap slot until x soft gaps slots are utilized for PDSCH transmissions. Slot 2 420 and slot 3 425 are hard gap slots as x slots have been scheduled with slot 1 415 being scheduled with a PDSCH transmission. Slot 4 430 may be a soft gap slot that may be scheduled or may not be scheduled. The window slides with each scheduled PDSCH transmission to insert gaps for the scheduled PDSCH transmission.

For a resource diagram 445, a PDSCH transmission may be scheduled in slot 0 450 and slot 1 455, slot 2 460, and slot 3 465 may be used for BB processing of the PDSCH transmission scheduled in slot 0 450. A window 480 may be associated with the PDSCH transmission scheduled in slot 0 450 and processed in slot 1 455, slot 2 460, and slot 3 465. Slot 1 455 may be a soft gap slot that is not scheduled with a PDSCH transmission. Slot 2 460 may be a soft gap slot that is scheduled with a second PDSCH transmission, and the second PDSCH transmission may be BB processed in slot 3 465, slot 4 470, and slot 5 475. A window 485 may be associated with the PDSCH transmission scheduled in slot 2 460 and processed in slot 3 465, slot 4 470, and slot 5 475. The UE does not expect more than x soft gaps in overlapped slots of scheduling windows, the remaining overlapped slots are hard gap slot that the UE 115-a may not be scheduled with PDSCH transmission. For the example where the UE 115-a may be scheduled with two PDSCH transmissions with the time window, the value of x may be one (e.g., two minus one). Any gap slot may be considered as a soft gap slot until x soft gaps slots are utilized for PDSCH transmissions. Slot 3 465 is a hard gap slot as x slots have been scheduled with slot 2 460 being scheduled with a PDSCH transmission. Slot 4 470 and slot 5 475 may be a soft gap slot that may be scheduled or may not be scheduled.

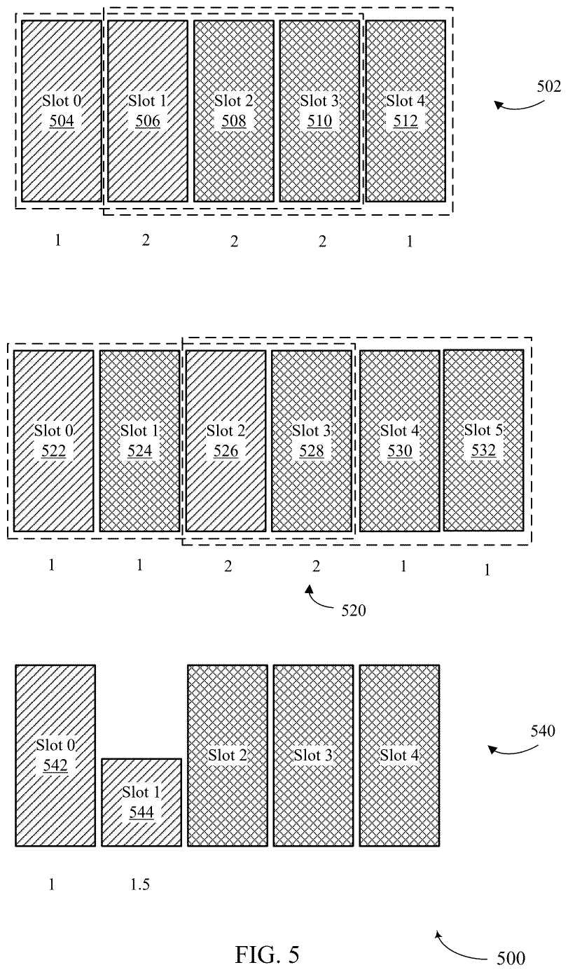

FIG. 5 shows examples of resource diagrams 500 that supports techniques for scheduling downlink data transmissions in accordance with one or more aspects of the present disclosure. The resource diagrams 500 illustrate example cases for the UE 115-a that may be scheduled with X PDSCH transmissions where Y slots are used for BB processing for each of the X PDSCH transmissions. The resource diagrams 500 may implement or be implemented by one or more aspects described with reference to FIGS. 1 and 2.

In some cases, the quantity of slots the UE is capable of being scheduled for downlink data transmissions may be conveyed as a quantity of simultaneous active data transmissions the UE is capable of being scheduled within a time window while operating in the reduced processing operational state. An active PDSCH counting may indicate how many simultaneous active PDSCH transmissions may be active at the UE 115-a. With the scheduled PDSCH transmission, the count may increase by one for a duration of a PDSCH transmission activity which may be transmitted, to the network entity 105-a, in the capability information 205. When the quantity of processing gaps or processing slots expire for the scheduled PDSCH transmission, the counting decreases by one.

For example, a resource diagram 502 illustrates a PDSCH transmission scheduled in slot 0 504, and slot 1 506, slot 2 508, and slot 3 510 may be used for BB processing of the PDSCH transmission scheduled in slot 0 504. Slot 0 504 may be associated with a corresponding active count of one indicating the one active PDSCH. Slot 1 506 may be scheduled with a second PDSCH transmission, and the second PDSCH transmission may be BB processed in slot 2 508, slot 3 510, and slot 4 512. Because two PDSCH transmissions are active in slot 1 506, slot 2 508, and slot 3 510, the active count for slot 1 506 may be two, the active count for slot 2 508 may be two, and the active count for slot 3 510 may be two. At slot 4 510, the PDSCH transmission scheduled in slot 0 504 has been BB processed, so the active count at slot 4 512 may be one.

For example, a resource diagram 520 illustrates a PDSCH transmission scheduled in slot 0 522, and slot 1 524, slot 2 526, and slot 3 528 may be used for BB processing of the PDSCH transmission scheduled in slot 0 522. Slot 0 522 may be associated with a corresponding active count of one indicating the one active PDSCH transmission. Slot 1 524 may not be scheduled with a PDSCH transmission, the active count for slot 1 524 may be one. Slot 2 526 may be scheduled with a second PDSCH transmission, and the second PDSCH transmission may be BB processed in slot 3 528, slot 4 530, and slot 5 532. Because two PDSCH transmissions are active in slot 2 526 and slot 3 528, the active count for slot 2 526 may be two, and the active count for slot 3 528 may be two. At slot 4 500, the PDSCH transmission scheduled in slot 0 522 has been BB processed, so the active count at slot 4 530 may be one. At slot 5 532, the second PDSCH transmission is active, and the active count may be one.

For active PDSCH counting, the default counting may be whole counting numbers, such as 0, 1, 2, and so on. In some cases, the active PDSCH counting may not be whole counting numbers, rather, the active counting may be a scaled quality, a fraction, or a ratio. In some examples, scaling for active counting may be based on frequency resources, time resources, or combination thereof. Ratios or fractions for the active count may be used to accommodate for different scaling in time, frequency, or both. A mapping between a quantity of resource elements or resource blocks scheduled and a relative count for the X resource elements or resource blocks may increment the counter by Y. In some cases, the scaling factor may be based on bandwidth. For example, 100% band bandwidth may be 1, 50% band bandwidth may be 0.5. For example, of the resource diagram 540, the active count for slot 0 542 may be 1 indicating 100% band bandwidth being scheduled for a PDSCH transmission in slot 0 542. The active count for slot 1 544 may be 1.5 indicating 100% band bandwidth being scheduled for a PDSCH transmission in slot 0 542 that has not yet been fully BB processed and 50% band bandwidth being scheduled for a PDSCH transmission in slot 1 544.

In some examples, the quantity of slots the UE is capable of being scheduled for downlink data transmissions within the time window may be based on a quantity of resource elements. For example, an equation may be used to set a limit on the quantity of resource elements, instead of coded bits, that may be scheduled in the time window.

In some cases, the capability information 205 for energy efficient scheduling (e.g., where a UE operates in the reduced processing operational state) may be based on UE capability. Instead of UE 115-a indicating the buffer size of the UE 115-a and how a quantity of PDSCH transmissions the UE 115-a may handle (e.g., while operating in the reduced processing operational state), the UE 115-a may indicate a quantity of hard gap slots or a quantity of soft gap slots in an overlapped window (e.g., while operating in the reduced processing operational state). The UE 115-a may indicate the capability in terms of a quantity of active PDSCH transmissions or the active PDSCH counting within a window of X slots (e.g., while operating in the reduced processing operational state). In some cases, the UE 115-a may indicate a duration of how long the PDSCH transmission is active which is different from active HARQ processes counting (e.g., while operating in the reduced processing operational state). In some examples, the UE 115-a may transmit, to the network entity 105-a, an indication 220 of the quantity of hard gap slots, the quantity of soft gap slots in the overlapped window, the quantity of active PDSCH transmissions, or the active PDSCH counting within the window, or any combination thereof (e.g., while operating in the reduced processing operational state).

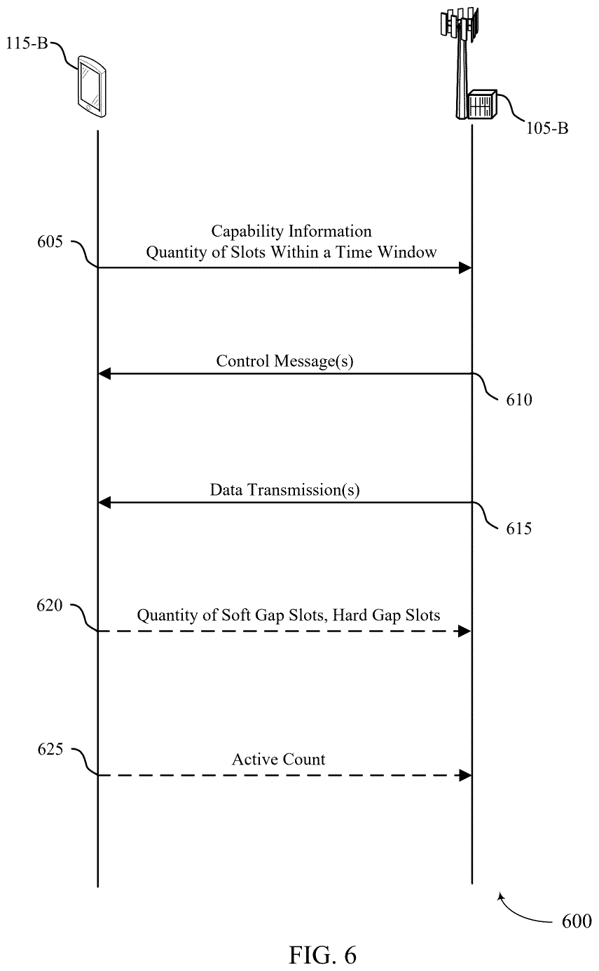

FIG. 6 shows an example of a process flow 600 that supports techniques for scheduling downlink data transmissions in accordance with one or more aspects of the present disclosure. The process flow 600 may implement or may be implemented by aspects of the wireless communications system 100 and the wireless communications system 200. For example, the process flow 600 may include a UE 115-b and a network entity 105-b which may be examples of corresponding devices and entities as described with reference to FIGS. 1 and 2. In the following description of the process flow 600, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 600, and other operations may be added to the process flow 600.

At 605, the UE 115-b may transmit, to the network entity 105-b, capability information that indicates a quantity of slots the UE 115-b is capable of being scheduled for downlink data transmissions within a time window while the UE 115-b is operating in a reduced processing operational state. The reduced processing operational state is associated with a first downlink data processing timeline that is different from a second downlink data processing timeline for a second processing operational state. In some cases, the capability information may include an indication of a duration associated with an active data transmission. In some cases, the quantity of slots the UE is capable of being scheduled for downlink data transmissions may equal a quantity of simultaneous active data transmissions the UE is capable of being scheduled within the time window while operating in the reduced processing operational state. In some cases, the quantity of slots the UE 115-b is capable of being scheduled for downlink data transmissions within the time window may be based on a quantity of resource elements.

At 610, the UE 115-b may receive, from the network entity 105-b, one or more control messages to schedule one or more data transmissions in up to the quantity of slots within a first time window in accordance with the capability information.

In some cases, the UE 115-b may receive, from the network entity 105-b, a first control message scheduling a first data transmission in a first slot within the first time window. The first time window may include a first quantity of soft gap slots and a first quantity of hard gap slots, where the one or more data transmissions are not scheduled in the hard gap slots and where the one or more data transmissions are scheduled in one or more of the soft gap slots. The first quantity of soft gaps slots may be equal to the quantity of slots the UE is capable of being scheduled for downlink data transmissions less one. The UE 115-b may receive, from the network entity 105-b, a second control message scheduling a second data transmission in a second slot within a second time window. An overlapping portion of the first time window and the second time window may include a second quantity of soft gap slots and a second quantity of hard gap slots, where the first quantity of soft gaps slots may be equal to the quantity of slots the UE is capable of being scheduled for downlink data transmissions less two.

In some cases, the UE 115-b may receive, from the network entity 105-b, a first control message scheduling a first data transmission in a first slot within the first time window, where an active count may be incremented by one for a duration associated with an active data transmission and the active count may be decremented by one after the duration. The UE 115-b may receive, from the network entity 105-b, a second control message scheduling a second data transmission in a second slot within the first time window, where the active count may be incremented by one for the duration associated with the active data transmission and the active count may be decremented by one after the duration.

In some cases, the UE 115-b may receive, from the network entity 105-b, a first control message scheduling a first data transmission in a first slot within the first time window, where an active count may be incremented by an amount associated with an amount of time resources or frequency resources of the first slot scheduled with the first data transmission.

At 615, the UE 115-b may receive, from the network entity 105-b, the one or more data transmissions within the first time window in accordance with the one or more control messages.

At 620, the UE 115-b may transmit, to the network entity 105-b, an indication of the second quantity of soft gap slots, the second quantity of hard gap slots, or both.

At 625, the UE 115-b may transmit, to the network entity 105-b, an indication of the active count.

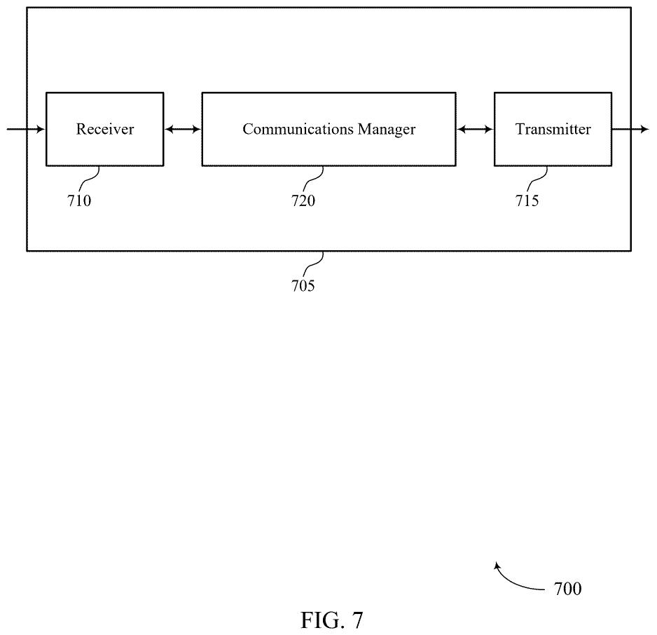

FIG. 7 shows a block diagram 700 of a device 705 that supports techniques for scheduling downlink data transmissions in accordance with one or more aspects of the present disclosure. The device 705 may be an example of aspects of a network entity 105 as described herein. The device 705 may include a receiver 710, a transmitter 715, and a communications manager 720. The device 705, or one or more components of the device 705 (e.g., the receiver 710, the transmitter 715, the communications manager 720), may include at least one or more processors, memory coupled with the one or more processors, and instructions stored in the memory that are executable by the one or more processors to enable the one or more processors to perform the scheduling of downlink data transmissions features discussed herein. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The communications manager 720, the receiver 710, the transmitter 715, or various combinations or components thereof may be examples of means for performing various aspects of techniques for scheduling downlink data transmissions as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. For example, the communications manager 720 is capable of, configured to, or operable to support a means for obtaining, from a UE, capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state. The communications manager 720 is capable of, configured to, or operable to support a means for outputting, to the UE, one or more control messages to schedule one or more data transmissions in up to the quantity of slots within a first time window in accordance with the capability information. The communications manager 720 is capable of, configured to, or operable to support a means for outputting the one or more data transmissions within the first time window in accordance with the one or more control messages.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources.

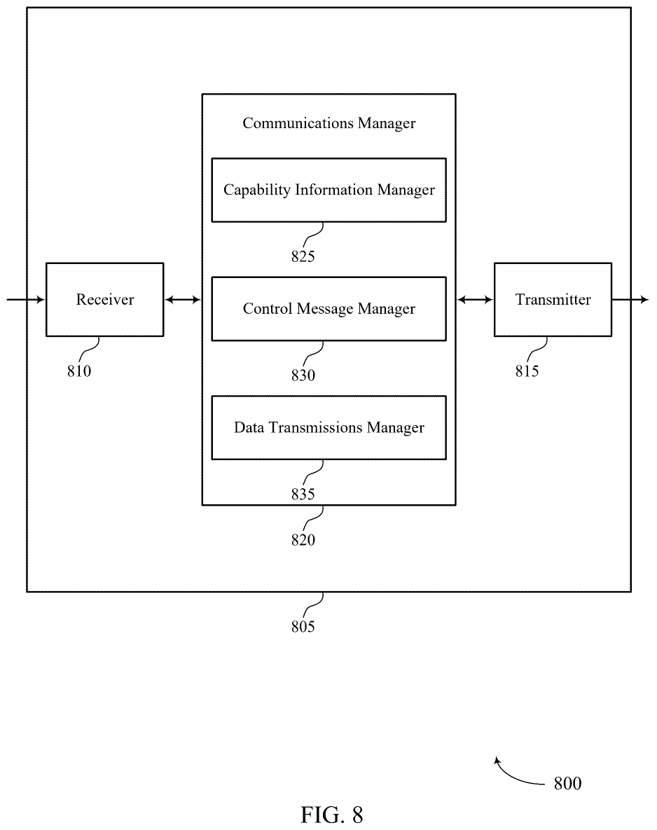

FIG. 8 shows a block diagram 800 of a device 805 that supports techniques for scheduling downlink data transmissions in accordance with one or more aspects of the present disclosure. The device 805 may be an example of aspects of a device 705 or a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The device 805, or various components thereof, may be an example of means for performing various aspects of techniques for scheduling downlink data transmissions as described herein. For example, the communications manager 820 may include a capability information manager 825, a control message manager 830, a data transmissions manager 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. The capability information manager 825 is capable of, configured to, or operable to support a means for obtaining, from a UE, capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state. The control message manager 830 is capable of, configured to, or operable to support a means for outputting, to the UE, one or more control messages to schedule one or more data transmissions in up to the quantity of slots within a first time window in accordance with the capability information. The data transmissions manager 835 is capable of, configured to, or operable to support a means for outputting the one or more data transmissions within the first time window in accordance with the one or more control messages.

In some cases, the capability information manager 825, control message manager 830, and the data transmission manager 835 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the capability information manager 825, control message manager 830, and the data transmission manager 835 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device

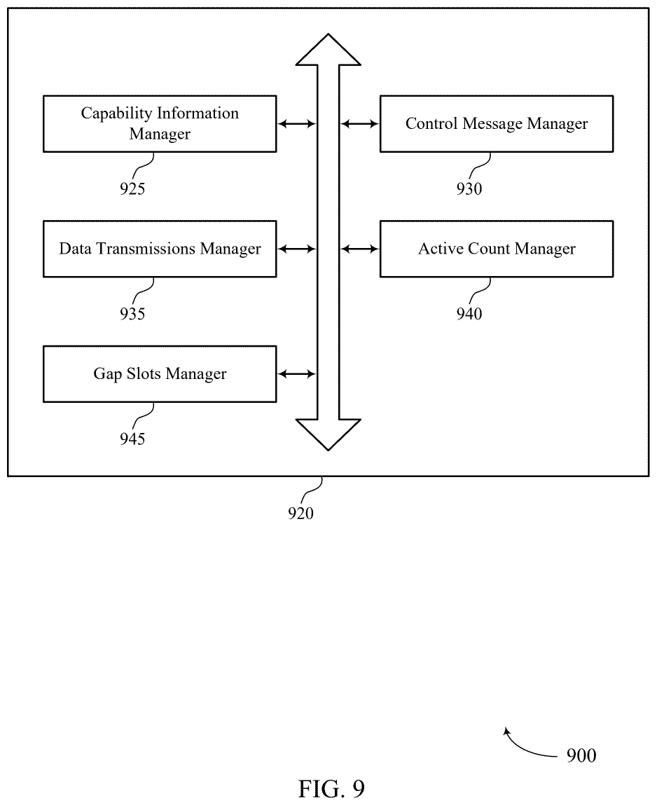

FIG. 9 shows a block diagram 900 of a communications manager 920 that supports techniques for scheduling downlink data transmissions in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for scheduling downlink data transmissions as described herein. For example, the communications manager 920 may include a capability information manager 925, a control message manager 930, a data transmissions manager 935, an active count manager 940, a gap slots manager 945, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 920 may support wireless communication in accordance with examples as disclosed herein. The capability information manager 925 is capable of, configured to, or operable to support a means for obtaining, from a UE, capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state. The control message manager 930 is capable of, configured to, or operable to support a means for outputting, to the UE, one or more control messages to schedule one or more data transmissions in up to the quantity of slots within a first time window in accordance with the capability information. The data transmissions manager 935 is capable of, configured to, or operable to support a means for outputting the one or more data transmissions within the first time window in accordance with the one or more control messages.

In some examples, to support outputting the one or more control messages, the control message manager 930 is capable of, configured to, or operable to support a means for outputting a first control message scheduling a first data transmission in a first slot within the first time window, where the first time window includes a first quantity of soft gap slots and a first quantity of hard gap slots, where the one or more data transmissions are not scheduled in the hard gap slots, and where the one or more data transmissions are scheduled in one or more of the soft gap slots.

In some examples, the first quantity of soft gaps slots is equal to the quantity of slots the UE is capable of being scheduled for downlink data transmissions less one.

In some examples, to support outputting the one or more control messages, the control message manager 930 is capable of, configured to, or operable to support a means for outputting a second control message scheduling a second data transmission in a second slot within a second time window, where an overlapping portion of the first time window and the second time window includes a second quantity of soft gap slots and a second quantity of hard gap slots, where the first quantity of soft gaps slots is equal to the quantity of slots the UE is capable of being scheduled for downlink data transmissions less two.

In some examples, the gap slots manager 945 is capable of, configured to, or operable to support a means for obtaining an indication of the second quantity of soft gap slots, the second quantity of hard gap slots, or both.

In some examples, the quantity of slots the UE is capable of being scheduled for downlink data transmissions equals a quantity of simultaneous active data transmissions the UE is capable of being scheduled within the time window while operating in the reduced processing operational state.

In some examples, to support outputting the one or more control messages, the control message manager 930 is capable of, configured to, or operable to support a means for outputting a first control message scheduling a first data transmission in a first slot within the first time window, where an active count is incremented by one for a duration associated with an active data transmission, and where the active count is decremented by one after the duration.

In some examples, to support outputting the one or more control messages, the control message manager 930 is capable of, configured to, or operable to support a means for outputting a second control message scheduling a second data transmission in a second slot within the first time window, where the active count is incremented by one for the duration associated with the active data transmission, where the active count is decremented by one after the duration.

In some examples, the active count manager 940 is capable of, configured to, or operable to support a means for obtaining an indication of the active count.

In some examples, to support outputting the one or more control messages, the control message manager 930 is capable of, configured to, or operable to support a means for outputting a first control message scheduling a first data transmission in a first slot within the first time window, where an active count is incremented by an amount associated with an amount of time resources or frequency resources of the first slot scheduled with the first data transmission.

In some examples, the quantity of slots the UE is capable of being scheduled for downlink data transmissions within the time window is based on a quantity of resource elements.

In some examples, to support obtaining the capability information, the capability information manager 925 is capable of, configured to, or operable to support a means for obtaining an indication of a duration associated with an active data transmission.

In some cases, the capability information manager 925, the control message manager 930, the data transmission manager, the active count manager 940, and the gap slots manager 945 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the capability information manager 925, the control message manager 930, the data transmission manager, the active count manager 940, and the gap slots manager 945 discussed herein

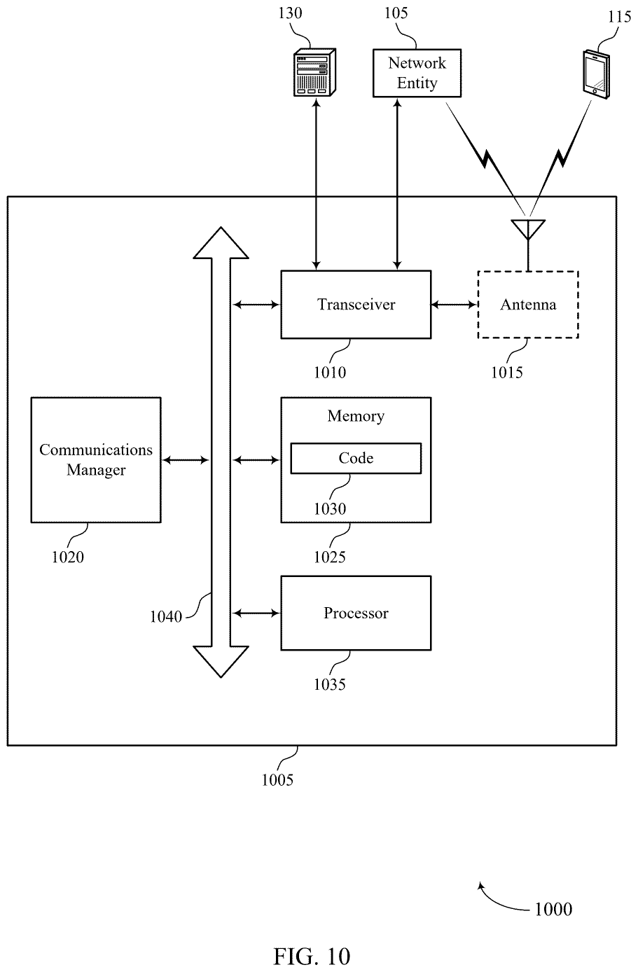

FIG. 10 shows a diagram of a system 1000 including a device 1005 that supports techniques for scheduling downlink data transmissions in accordance with one or more aspects of the present disclosure. The device 1005 may be an example of or include components of a device 705, a device 805, or a network entity 105 as described herein. The device 1005 may communicate with other network devices or network equipment such as one or more of the network entities 105, UEs 115, or any combination thereof. The communications may include communications over one or more wired interfaces, over one or more wireless interfaces, or any combination thereof. The device 1005 may include components that support outputting and obtaining communications, such as a communications manager 1020, a transceiver 1010, one or more antennas 1015, at least one memory 1025, code 1030, and at least one processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or one or more memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or one or more memory components (e.g., the at least one processor 1035, the at least one memory 1025, or both), may be included in a chip or chip assembly that is installed in the device 1005. In some examples, the transceiver 1010 may be operable to support communications via one or more communications links (e.g., communication link(s) 125, backhaul communication link(s) 120, a midhaul communication link 162, a fronthaul communication link 168).

The at least one memory 1025 may include RAM, ROM, or any combination thereof. The at least one memory 1025 may store computer-readable, computer-executable, or processor-executable code, such as the code 1030. The code 1030 may include instructions that, when executed by one or more of the at least one processor 1035, cause the device 1005 to perform various functions described herein. The code 1030 may be stored in a non-transitory computer-readable medium such as system memory or another type of memory. In some cases, the code 1030 may not be directly executable by a processor of the at least one processor 1035 but may cause a computer (e.g., when compiled and executed) to perform functions described herein. In some cases, the at least one memory 1025 may include, among other things, a BIOS which may control basic hardware or software operation such as the interaction with peripheral components or devices. In some examples, the at least one processor 1035 may include multiple processors and the at least one memory 1025 may include multiple memories. One or more of the multiple processors may be coupled with one or more of the multiple memories which may, individually or collectively, be configured to perform various functions herein (for example, as part of a processing system).

The at least one processor 1035 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1035 may be configured to operate a memory array using a memory controller. In some other cases, a memory controller may be integrated into one or more of the at least one processor 1035. The at least one processor 1035 may be configured to execute computer-readable instructions stored in a memory (e.g., one or more of the at least one memory 1025) to cause the device 1005 to perform various functions (e.g., functions or tasks supporting techniques for scheduling downlink data transmissions). For example, the device 1005 or a component of the device 1005 may include at least one processor 1035 and at least one memory 1025 coupled with one or more of the at least one processor 1035, the at least one processor 1035 and the at least one memory 1025 configured to perform various functions described herein. The at least one processor 1035 may be an example of a cloud-computing platform (e.g., one or more physical nodes and supporting software such as operating systems, virtual machines, or container instances) that may host the functions (e.g., by executing code 1030) to perform the functions of the device 1005. The at least one processor 1035 may be any one or more suitable processors capable of executing scripts or instructions of one or more software programs stored in the device 1005 (such as within one or more of the at least one memory 1025).

In some examples, the at least one processor 1035 may include multiple processors and the at least one memory 1025 may include multiple memories. One or more of the multiple processors may be coupled with one or more of the multiple memories, which may, individually or collectively, be configured to perform various functions herein. In some examples, the at least one processor 1035 may be a component of a processing system, which may refer to a system (such as a series) of machines, circuitry (including, for example, one or both of processor circuitry (which may include the at least one processor 1035) and memory circuitry (which may include the at least one memory 1025)), or components, that receives or obtains inputs and processes the inputs to produce, generate, or obtain a set of outputs. The processing system may be configured to perform one or more of the functions described herein. For example, the at least one processor 1035 or a processing system including the at least one processor 1035 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1025 or otherwise, to perform one or more of the functions described herein.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the at least one memory 1025, the code 1030, and the at least one processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with one or more other network entities 105, and may include a controller or scheduler for controlling communications with UEs 115 (e.g., in cooperation with the one or more other network devices). In some examples, the communications manager 1020 may support an X2 interface within an LTE/LTE-A wireless communications network technology to provide communication between network entities 105.

The communications manager 1020 may support wireless communication in accordance with examples as disclosed herein. For example, the communications manager 1020 is capable of, configured to, or operable to support a means for obtaining, from a UE, capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state. The communications manager 1020 is capable of, configured to, or operable to support a means for outputting, to the UE, one or more control messages to schedule one or more data transmissions in up to the quantity of slots within a first time window in accordance with the capability information. The communications manager 1020 is capable of, configured to, or operable to support a means for outputting the one or more data transmissions within the first time window in accordance with the one or more control messages.

By including or configuring the communications manager 1020 in accordance with examples as described herein, the device 1005 may support techniques for improved communication reliability, more efficient utilization of communication resources, and improved coordination between devices.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, one or more of the at least one processor 1035, one or more of the at least one memory 1025, the code 1030, or any combination thereof (for example, by a processing system including at least a portion of the at least one processor 1035, the at least one memory 1025, the code 1030, or any combination thereof). For example, the code 1030 may include instructions executable by one or more of the at least one processor 1035 to cause the device 1005 to perform various aspects of techniques for scheduling downlink data transmissions as described herein, or the at least one processor 1035 and the at least one memory 1025 may be otherwise configured to, individually or collectively, perform or support such operations.

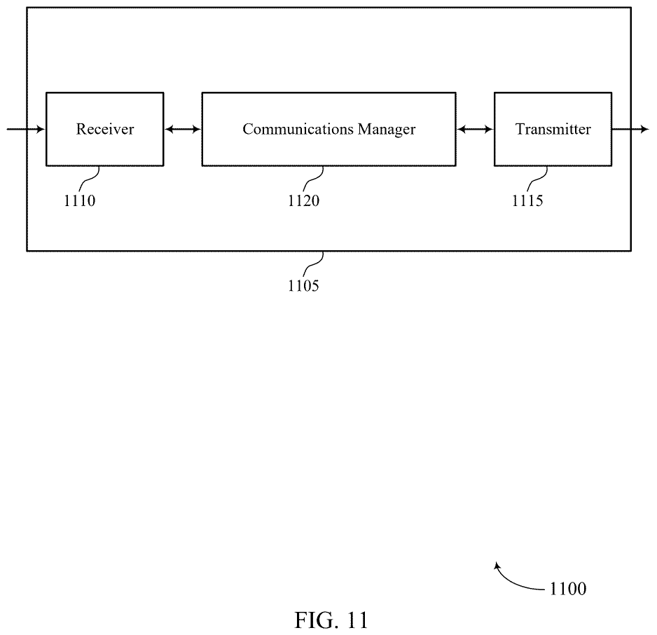

FIG. 11 shows a block diagram 1100 of a device 1105 that supports techniques for scheduling downlink data transmissions in accordance with one or more aspects of the present disclosure. The device 1105 may be an example of aspects of a UE 115 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to techniques for scheduling downlink data transmissions). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to techniques for scheduling downlink data transmissions). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations or components thereof may be examples of means for performing various aspects of techniques for scheduling downlink data transmissions as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. For example, the communications manager 1120 is capable of, configured to, or operable to support a means for transmitting capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state. The communications manager 1120 is capable of, configured to, or operable to support a means for receiving one or more control messages to schedule one or more data transmissions in up to the quantity of slots within a first time window in accordance with the capability information. The communications manager 1120 is capable of, configured to, or operable to support a means for receiving the one or more data transmissions within the first time window in accordance with the one or more control messages.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for more efficient utilization of communication resources.

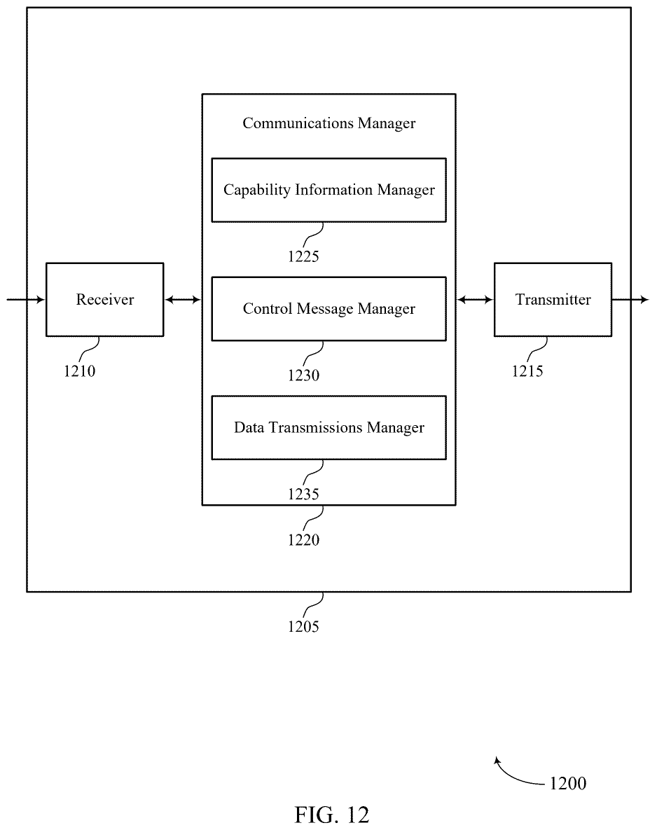

FIG. 12 shows a block diagram 1200 of a device 1205 that supports techniques for scheduling downlink data transmissions in accordance with one or more aspects of the present disclosure. The device 1205 may be an example of aspects of a device 1105 or a UE 115 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to techniques for scheduling downlink data transmissions). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to techniques for scheduling downlink data transmissions). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of techniques for scheduling downlink data transmissions as described herein. For example, the communications manager 1220 may include a capability information manager 1225, a control message manager 1230, a data transmissions manager 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication in accordance with examples as disclosed herein. The capability information manager 1225 is capable of, configured to, or operable to support a means for transmitting capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state. The control message manager 1230 is capable of, configured to, or operable to support a means for receiving one or more control messages to schedule one or more data transmissions in up to the quantity of slots within a first time window in accordance with the capability information. The data transmissions manager 1235 is capable of, configured to, or operable to support a means for receiving the one or more data transmissions within the first time window in accordance with the one or more control messages.

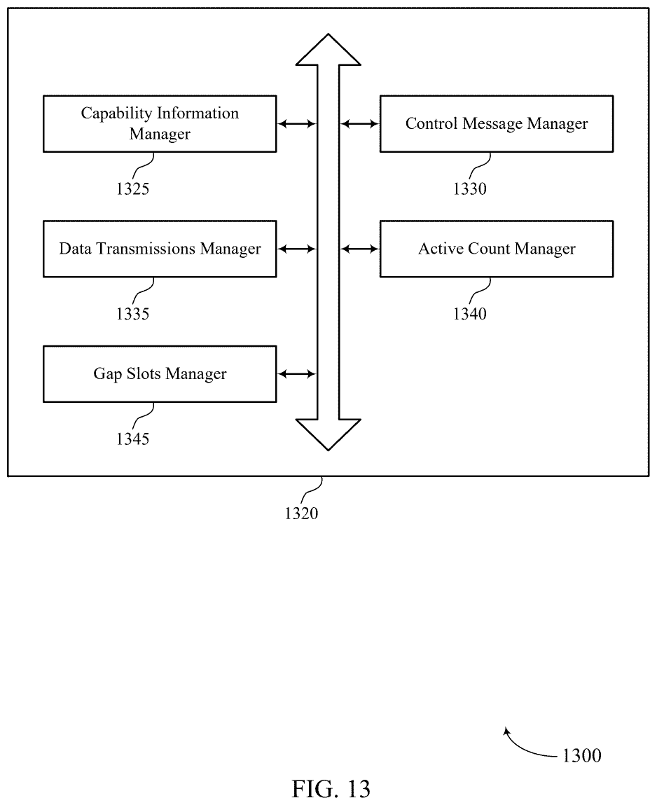

FIG. 13 shows a block diagram 1300 of a communications manager 1320 that supports techniques for scheduling downlink data transmissions in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for scheduling downlink data transmissions as described herein. For example, the communications manager 1320 may include a capability information manager 1325, a control message manager 1330, a data transmissions manager 1335, an active count manager 1340, a gap slots manager 1345, or any combination thereof. Each of these components, or components or subcomponents thereof (e.g., one or more processors, one or more memories), may communicate, directly or indirectly, with one another (e.g., via one or more buses).

The communications manager 1320 may support wireless communication in accordance with examples as disclosed herein. The capability information manager 1325 is capable of, configured to, or operable to support a means for transmitting capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state. The control message manager 1330 is capable of, configured to, or operable to support a means for receiving one or more control messages to schedule one or more data transmissions in up to the quantity of slots within a first time window in accordance with the capability information. The data transmissions manager 1335 is capable of, configured to, or operable to support a means for receiving the one or more data transmissions within the first time window in accordance with the one or more control messages.

In some examples, to support receiving the one or more control messages, the control message manager 1330 is capable of, configured to, or operable to support a means for receiving a first control message scheduling a first data transmission in a first slot within the first time window, where the first time window includes a first quantity of soft gap slots and a first quantity of hard gap slots, where the one or more data transmissions are not scheduled in the hard gap slots, and where the one or more data transmissions are scheduled in one or more of the soft gap slots.

In some examples, the first quantity of soft gaps slots is equal to the quantity of slots the UE is capable of being scheduled for downlink data transmissions less one.

In some examples, to support receiving the one or more control messages, the control message manager 1330 is capable of, configured to, or operable to support a means for receiving a second control message scheduling a second data transmission in a second slot within a second time window, where an overlapping portion of the first time window and the second time window includes a second quantity of soft gap slots and a second quantity of hard gap slots, where the first quantity of soft gaps slots is equal to the quantity of slots the UE is capable of being scheduled for downlink data transmissions less two.

In some examples, the gap slots manager 1345 is capable of, configured to, or operable to support a means for transmitting an indication of the second quantity of soft gap slots, the second quantity of hard gap slots, or both.

In some examples, the quantity of slots the UE is capable of being scheduled for downlink data transmissions equals a quantity of simultaneous active data transmissions the UE is capable of being scheduled within the time window while operating in the reduced processing operational state.

In some examples, to support receiving the one or more control messages, the control message manager 1330 is capable of, configured to, or operable to support a means for receiving a first control message scheduling a first data transmission in a first slot within the first time window, where an active count is incremented by one for a duration associated with an active data transmission, and where the active count is decremented by one after the duration.

In some examples, to support receiving the one or more control messages, the control message manager 1330 is capable of, configured to, or operable to support a means for receiving a second control message scheduling a second data transmission in a second slot within the first time window, where the active count is incremented by one for the duration associated with the active data transmission, where the active count is decremented by one after the duration.

In some examples, the active count manager 1340 is capable of, configured to, or operable to support a means for transmitting an indication of the active count.

In some examples, to support receiving the one or more control messages, the control message manager 1330 is capable of, configured to, or operable to support a means for receiving a first control message scheduling a first data transmission in a first slot within the first time window, where an active count is incremented by an amount associated with an amount of time resources or frequency resources of the first slot scheduled with the first data transmission.

In some examples, the quantity of slots the UE is capable of being scheduled for downlink data transmissions within the time window is based on a quantity of resource elements.

In some examples, to support transmitting the capability information, the capability information manager 1325 is capable of, configured to, or operable to support a means for transmitting an indication of a duration associated with an active data transmission.

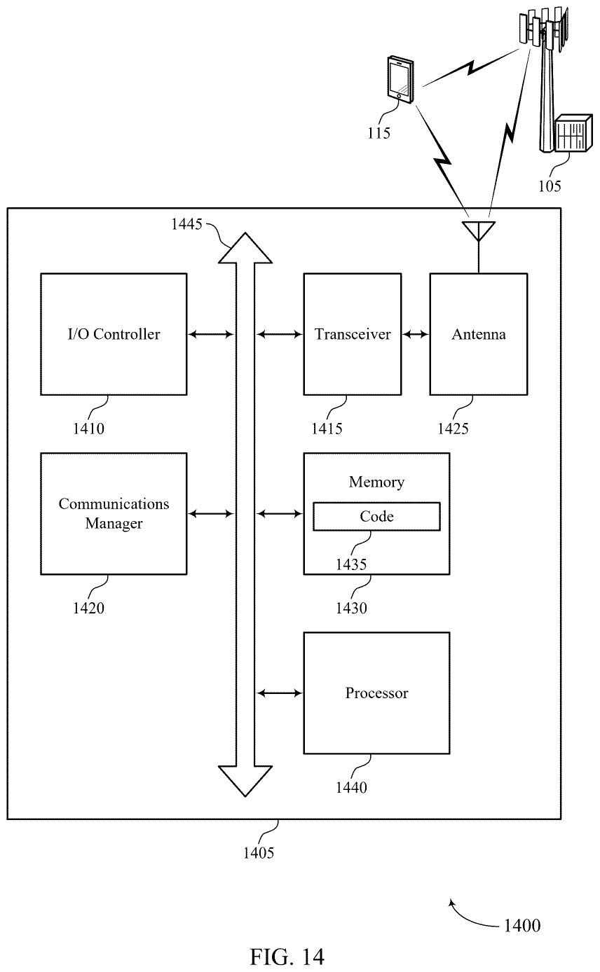

FIG. 14 shows a diagram of a system 1400 including a device 1405 that supports techniques for scheduling downlink data transmissions in accordance with one or more aspects of the present disclosure. The device 1405 may be an example of or include components of a device 1105, a device 1205, or a UE 115 as described herein. The device 1405 may communicate (e.g., wirelessly) with one or more other devices (e.g., network entities 105, UEs 115, or a combination thereof). The device 1405 may include components for bi-directional voice and data communications including components for transmitting and receiving communications, such as a communications manager 1420, an input/output (I/O) controller, such as an I/O controller 1410, a transceiver 1415, one or more antennas 1425, at least one memory 1430, code 1435, and at least one processor 1440. These components may be in electronic communication or otherwise coupled (e.g., operatively, communicatively, functionally, electronically, electrically) via one or more buses (e.g., a bus 1445).

The I/O controller 1410 may manage input and output signals for the device 1405. The I/O controller 1410 may also manage peripherals not integrated into the device 1405. In some cases, the I/O controller 1410 may represent a physical connection or port to an external peripheral. In some cases, the I/O controller 1410 may utilize an operating system such as iOS®, ANDROID®, MS-DOS®, MS-WINDOWS®, OS/2®, UNIX®, LINUX®, or another known operating system. Additionally, or alternatively, the I/O controller 1410 may represent or interact with a modem, a keyboard, a mouse, a touchscreen, or a similar device. In some cases, the I/O controller 1410 may be implemented as part of one or more processors, such as the at least one processor 1440. In some cases, a user may interact with the device 1405 via the I/O controller 1410 or via hardware components controlled by the I/O controller 1410.

In some cases, the device 1405 may include a single antenna. However, in some other cases, the device 1405 may have more than one antenna, which may be capable of concurrently transmitting or receiving multiple wireless transmissions. The transceiver 1415 may communicate bi-directionally via the one or more antennas 1425 using wired or wireless links as described herein. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof, as described herein.

The at least one memory 1430 may include random access memory (RAM) and read-only memory (ROM). The at least one memory 1430 may store computer-readable, computer-executable, or processor-executable code, such as the code 1435. The code 1435 may include instructions that, when executed by the at least one processor 1440, cause the device 1405 to perform various functions described herein. The code 1435 may be stored in a non-transitory computer-readable medium such as system memory or another type of memory. In some cases, the code 1435 may not be directly executable by the at least one processor 1440 but may cause a computer (e.g., when compiled and executed) to perform functions described herein. In some cases, the at least one memory 1430 may include, among other things, a basic I/O system (BIOS) which may control basic hardware or software operation such as the interaction with peripheral components or devices.

The at least one processor 1440 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1440 may be configured to operate a memory array using a memory controller. In some other cases, a memory controller may be integrated into the at least one processor 1440. The at least one processor 1440 may be configured to execute computer-readable instructions stored in a memory (e.g., the at least one memory 1430) to cause the device 1405 to perform various functions (e.g., functions or tasks supporting techniques for scheduling downlink data transmissions). For example, the device 1405 or a component of the device 1405 may include at least one processor 1440 and at least one memory 1430 coupled with or to the at least one processor 1440, the at least one processor 1440 and the at least one memory 1430 configured to perform various functions described herein.

In some examples, the at least one processor 1440 may include multiple processors and the at least one memory 1430 may include multiple memories. One or more of the multiple processors may be coupled with one or more of the multiple memories, which may, individually or collectively, be configured to perform various functions described herein. In some examples, the at least one processor 1440 may be a component of a processing system, which may refer to a system (such as a series) of machines, circuitry (including, for example, one or both of processor circuitry (which may include the at least one processor 1440) and memory circuitry (which may include the at least one memory 1430)), or components, that receives or obtains inputs and processes the inputs to produce, generate, or obtain a set of outputs. The processing system may be configured to perform one or more of the functions described herein. For example, the at least one processor 1440 or a processing system including the at least one processor 1440 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code 1435 (e.g., processor-executable code) stored in the at least one memory 1430 or otherwise, to perform one or more of the functions described herein.

The communications manager 1420 may support wireless communication in accordance with examples as disclosed herein. For example, the communications manager 1420 is capable of, configured to, or operable to support a means for transmitting capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state. The communications manager 1420 is capable of, configured to, or operable to support a means for receiving one or more control messages to schedule one or more data transmissions in up to the quantity of slots within a first time window in accordance with the capability information. The communications manager 1420 is capable of, configured to, or operable to support a means for receiving the one or more data transmissions within the first time window in accordance with the one or more control messages.

By including or configuring the communications manager 1420 in accordance with examples as described herein, the device 1405 may support techniques for improved communication reliability, more efficient utilization of communication resources, and improved coordination between devices.

In some examples, the communications manager 1420 may be configured to perform various operations (e.g., receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the at least one processor 1440, the at least one memory 1430, the code 1435, or any combination thereof. For example, the code 1435 may include instructions executable by the at least one processor 1440 to cause the device 1405 to perform various aspects of techniques for scheduling downlink data transmissions as described herein, or the at least one processor 1440 and the at least one memory 1430 may be otherwise configured to, individually or collectively, perform or support such operations.

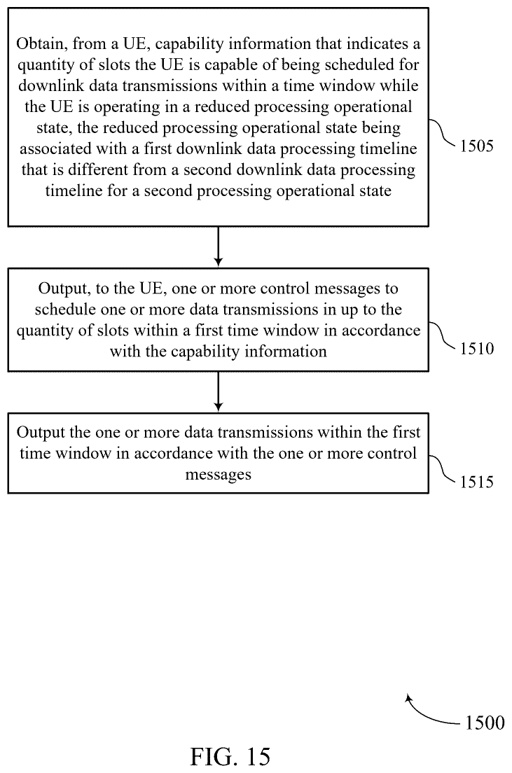

FIG. 15 shows a flowchart illustrating a method 1500 that supports techniques for scheduling downlink data transmissions in accordance with one or more aspects of the present disclosure. The operations of the method 1500 may be implemented by a network entity or its components as described herein. For example, the operations of the method 1500 may be performed by a network entity as described with reference to FIGS. 1 through 10. In some examples, a network entity may execute a set of instructions to control the functional elements of the network entity to perform the described functions. Additionally, or alternatively, the network entity may perform aspects of the described functions using special-purpose hardware.

At 1505, the method may include obtaining, from a UE, capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state. The operations of 1505 may be performed in accordance with examples as disclosed herein. In some examples, aspects of the operations of 1505 may be performed by a capability information manager 925 as described with reference to FIG. 9.

At 1510, the method may include outputting, to the UE, one or more control messages to schedule one or more data transmissions in up to the quantity of slots within a first time window in accordance with the capability information. The operations of 1510 may be performed in accordance with examples as disclosed herein. In some examples, aspects of the operations of 1510 may be performed by a control message manager 930 as described with reference to FIG. 9.

At 1515, the method may include outputting the one or more data transmissions within the first time window in accordance with the one or more control messages. The operations of 1515 may be performed in accordance with examples as disclosed herein. In some examples, aspects of the operations of 1515 may be performed by a data transmissions manager 935 as described with reference to FIG. 9.

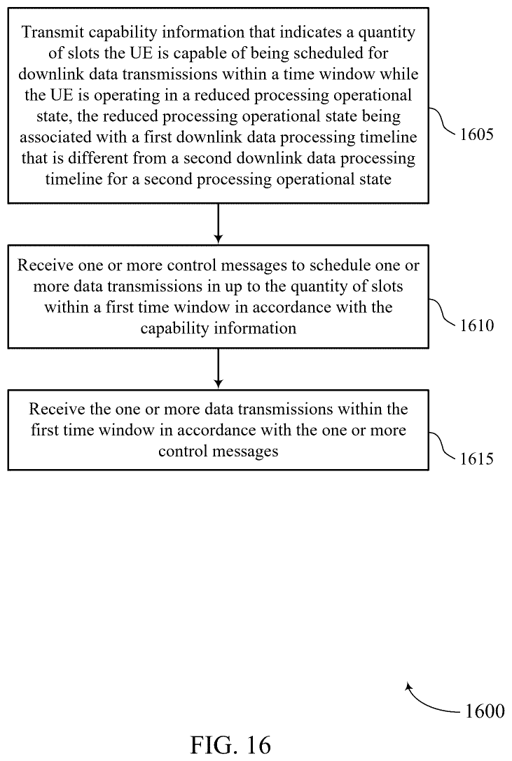

FIG. 16 shows a flowchart illustrating a method 1600 that supports techniques for scheduling downlink data transmissions in accordance with one or more aspects of the present disclosure. The operations of the method 1600 may be implemented by a UE or its components as described herein. For example, the operations of the method 1600 may be performed by a UE 115 as described with reference to FIGS. 1 through 6 and 11 through 14. In some examples, a UE may execute a set of instructions to control the functional elements of the UE to perform the described functions. Additionally, or alternatively, the UE may perform aspects of the described functions using special-purpose hardware.

At 1605, the method may include transmitting capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state. The operations of 1605 may be performed in accordance with examples as disclosed herein. In some examples, aspects of the operations of 1605 may be performed by a capability information manager 1325 as described with reference to FIG. 13.

At 1610, the method may include receiving one or more control messages to schedule one or more data transmissions in up to the quantity of slots within a first time window in accordance with the capability information. The operations of 1610 may be performed in accordance with examples as disclosed herein. In some examples, aspects of the operations of 1610 may be performed by a control message manager 1330 as described with reference to FIG. 13.

At 1615, the method may include receiving the one or more data transmissions within the first time window in accordance with the one or more control messages. The operations of 1615 may be performed in accordance with examples as disclosed herein. In some examples, aspects of the operations of 1615 may be performed by a data transmissions manager 1335 as described with reference to FIG. 13.

The following provides an overview of aspects of the present disclosure:

Aspect 1: A method for wireless communication by network entity, comprising: obtaining, from a UE, capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state; outputting, to the UE, one or more control messages to schedule one or more data transmissions in up to the quantity of slots within a first time window in accordance with the capability information; and outputting the one or more data transmissions within the first time window in accordance with the one or more control messages.

Aspect 2: The method of aspect 1, wherein outputting the one or more control messages further comprises: outputting a first control message scheduling a first data transmission in a first slot within the first time window, wherein the first time window comprises a first quantity of soft gap slots and a first quantity of hard gap slots, wherein the one or more data transmissions are not scheduled in the hard gap slots, and wherein the one or more data transmissions are scheduled in one or more of the soft gap slots.

Aspect 3: The method of aspect 2, wherein the first quantity of soft gaps slots is equal to the quantity of slots the UE is capable of being scheduled for downlink data transmissions less one.

Aspect 4: The method of aspect 2, wherein outputting the one or more control messages further comprises: outputting a second control message scheduling a second data transmission in a second slot within a second time window, wherein an overlapping portion of the first time window and the second time window comprises a second quantity of soft gap slots and a second quantity of hard gap slots, wherein the first quantity of soft gaps slots is equal to the quantity of slots the UE is capable of being scheduled for downlink data transmissions less two.

Aspect 5: The method of aspect 4, further comprising: obtaining an indication of the second quantity of soft gap slots, the second quantity of hard gap slots, or both.

Aspect 6: The method of aspect 1, wherein the quantity of slots the UE is capable of being scheduled for downlink data transmissions equals a quantity of simultaneous active data transmissions the UE is capable of being scheduled within the time window while operating in the reduced processing operational state.

Aspect 7: The method of aspect 1, wherein outputting the one or more control messages further comprises: outputting a first control message scheduling a first data transmission in a first slot within the first time window, wherein an active count is incremented by one for a duration associated with an active data transmission, and wherein the active count is decremented by one after the duration.

Aspect 8: The method of aspect 7, wherein outputting the one or more control messages further comprises: outputting a second control message scheduling a second data transmission in a second slot within the first time window, wherein the active count is incremented by one for the duration associated with the active data transmission, wherein the active count is decremented by one after the duration.

Aspect 9: The method of any of aspects 7 through 8, further comprising: obtaining an indication of the active count.

Aspect 10: The method of aspect 1, wherein outputting the one or more control messages further comprises: outputting a first control message scheduling a first data transmission in a first slot within the first time window, wherein an active count is incremented by an amount associated with an amount of time resources or frequency resources of the first slot scheduled with the first data transmission.

Aspect 11: The method of aspect 1, wherein the quantity of slots the UE is capable of being scheduled for downlink data transmissions within the time window is based at least in part on a quantity of resource elements.

Aspect 12: The method of any of aspects 1 through 11, wherein obtaining the capability information further comprises: obtaining an indication of a duration associated with an active data transmission.

Aspect 13: A method for wireless communication by UE, comprising: transmitting capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state; receiving one or more control messages to schedule one or more data transmissions in up to the quantity of slots within a first time window in accordance with the capability information; and receiving the one or more data transmissions within the first time window in accordance with the one or more control messages.

Aspect 14: The method of aspect 13, wherein receiving the one or more control messages further comprises: receiving a first control message scheduling a first data transmission in a first slot within the first time window, wherein the first time window comprises a first quantity of soft gap slots and a first quantity of hard gap slots, wherein the one or more data transmissions are not scheduled in the hard gap slots, and wherein the one or more data transmissions are scheduled in one or more of the soft gap slots.

Aspect 15: The method of aspect 14, wherein the first quantity of soft gaps slots is equal to the quantity of slots the UE is capable of being scheduled for downlink data transmissions less one.

Aspect 16: The method of aspects 14, wherein receiving the one or more control messages further comprises: receiving a second control message scheduling a second data transmission in a second slot within a second time window, wherein an overlapping portion of the first time window and the second time window comprises a second quantity of soft gap slots and a second quantity of hard gap slots, wherein the first quantity of soft gaps slots is equal to the quantity of slots the UE is capable of being scheduled for downlink data transmissions less two.

Aspect 17: The method of aspect 16, further comprising: transmitting an indication of the second quantity of soft gap slots, the second quantity of hard gap slots, or both.

Aspect 18: The method of aspect 13, wherein the quantity of slots the UE is capable of being scheduled for downlink data transmissions equals a quantity of simultaneous active data transmissions the UE is capable of being scheduled within the time window while operating in the reduced processing operational state.

Aspect 19: The method of aspect 13, wherein receiving the one or more control messages further comprises: receiving a first control message scheduling a first data transmission in a first slot within the first time window, wherein an active count is incremented by one for a duration associated with an active data transmission, and wherein the active count is decremented by one after the duration.

Aspect 20: The method of aspect 19, wherein receiving the one or more control messages further comprises: receiving a second control message scheduling a second data transmission in a second slot within the first time window, wherein the active count is incremented by one for the duration associated with the active data transmission, wherein the active count is decremented by one after the duration.

Aspect 21: The method of any of aspects 19 through 20, further comprising: transmitting an indication of the active count.

Aspect 22: The method of aspect 13, wherein receiving the one or more control messages further comprises: receiving a first control message scheduling a first data transmission in a first slot within the first time window, wherein an active count is incremented by an amount associated with an amount of time resources or frequency resources of the first slot scheduled with the first data transmission.

Aspect 23: The method of aspect 13, wherein the quantity of slots the UE is capable of being scheduled for downlink data transmissions within the time window is based at least in part on a quantity of resource elements.

Aspect 24: The method of any of aspects 13 through 23, wherein transmitting the capability information further comprises: transmitting an indication of a duration associated with an active data transmission.

Aspect 25: A network entity for wireless communication, comprising one or more memories storing processor-executable code, and one or more processors coupled with the one or more memories and individually or collectively operable to execute the code to cause the network entity to perform a method of any of aspects 1 through 12.

Aspect 26: A network entity for wireless communication, comprising at least one means for performing a method of any of aspects 1 through 12.

Aspect 27: A non-transitory computer-readable medium storing code for wireless communication, the code comprising instructions executable by one or more processors to perform a method of any of aspects 1 through 12.

Aspect 28: A UE for wireless communication, comprising one or more memories storing processor-executable code, and one or more processors coupled with the one or more memories and individually or collectively operable to execute the code to cause the UE to perform a method of any of aspects 13 through 24.

Aspect 29: A UE for wireless communication, comprising at least one means for performing a method of any of aspects 13 through 24.

Aspect 30: A non-transitory computer-readable medium storing code for wireless communication, the code comprising instructions executable by one or more processors to perform a method of any of aspects 13 through 24.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and one or more processors coupled with the one or more memories and individually or collectively operable to execute the code to cause the network entity to:
obtain, from a user equipment (UE), capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state;
output, to the UE, one or more control messages to schedule one or more data transmissions in up to the quantity of slots within a first time window in accordance with the capability information; and
output the one or more data transmissions within the first time window in accordance with the one or more control messages.

2. The network entity of claim 1, wherein, to output the one or more control messages, the one or more processors are individually or collectively further operable to execute the code to cause the network entity to:
output a first control message scheduling a first data transmission in a first slot within the first time window, wherein the first time window comprises a first quantity of soft gap slots and a first quantity of hard gap slots, wherein the one or more data transmissions are not scheduled in the hard gap slots, and wherein the one or more data transmissions are scheduled in one or more of the soft gap slots.

3. The network entity of claim 2, wherein the first quantity of soft gaps slots is equal to the quantity of slots the UE is capable of being scheduled for downlink data transmissions less one.

4. The network entity of claim 2, wherein, to output the one or more control messages, the one or more processors are individually or collectively further operable to execute the code to cause the network entity to:
output a second control message scheduling a second data transmission in a second slot within a second time window, wherein an overlapping portion of the first time window and the second time window comprises a second quantity of soft gap slots and a second quantity of hard gap slots, and wherein the first quantity of soft gaps slots is equal to the quantity of slots the UE is capable of being scheduled for downlink data transmissions less two.

5. The network entity of claim 4, wherein the one or more processors are individually or collectively further operable to execute the code to cause the network entity to:
obtain an indication of the second quantity of soft gap slots, the second quantity of hard gap slots, or both.

6. The network entity of claim 1, wherein the quantity of slots the UE is capable of being scheduled for downlink data transmissions equals a quantity of simultaneous active data transmissions the UE is capable of being scheduled within the time window while operating in the reduced processing operational state.

7. The network entity of claim 1, wherein, to output the one or more control messages, the one or more processors are individually or collectively further operable to execute the code to cause the network entity to:
output a first control message scheduling a first data transmission in a first slot within the first time window, wherein an active count is incremented by one for a duration associated with an active data transmission, and wherein the active count is decremented by one after the duration.

8. The network entity of claim 7, wherein, to output the one or more control messages, the one or more processors are individually or collectively further operable to execute the code to cause the network entity to:
output a second control message scheduling a second data transmission in a second slot within the first time window, wherein the active count is incremented by one for the duration associated with the active data transmission, wherein the active count is decremented by one after the duration.

9. The network entity of claim 7, wherein the one or more processors are individually or collectively further operable to execute the code to cause the network entity to:
obtain an indication of the active count.

10. The network entity of claim 1, wherein, to output the one or more control messages, the one or more processors are individually or collectively further operable to execute the code to cause the network entity to:
output a first control message scheduling a first data transmission in a first slot within the first time window, wherein an active count is incremented by an amount associated with an amount of time resources or frequency resources of the first slot scheduled with the first data transmission.

11. The network entity of claim 1, wherein the quantity of slots the UE is capable of being scheduled for downlink data transmissions within the time window is based at least in part on a quantity of resource elements.

12. The network entity of claim 1, wherein, to obtain the capability information, the one or more processors are individually or collectively further operable to execute the code to cause the network entity to:
obtain an indication of a duration associated with an active data transmission.

13. A user equipment (UE), comprising:
one or more memories storing processor-executable code; and
one or more processors coupled with the one or more memories and individually or collectively operable to execute the code to cause the UE to:
transmit capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state;
receive one or more control messages to schedule one or more data transmissions in up to the quantity of slots within a first time window in accordance with the capability information; and
receive the one or more data transmissions within the first time window in accordance with the one or more control messages.

14. The UE of claim 13, wherein, to receive the one or more control messages, the one or more processors are individually or collectively further operable to execute the code to cause the UE to:
receive a first control message scheduling a first data transmission in a first slot within the first time window, wherein the first time window comprises a first quantity of soft gap slots and a first quantity of hard gap slots, wherein the one or more data transmissions are not scheduled in the hard gap slots, and wherein the one or more data transmissions are scheduled in one or more of the soft gap slots.

15. The UE of claim 14, wherein the first quantity of soft gaps slots is equal to the quantity of slots the UE is capable of being scheduled for downlink data transmissions less one.

16. The UE of claim 14, wherein, to receive the one or more control messages, the one or more processors are individually or collectively further operable to execute the code to cause the UE to:
receive a second control message scheduling a second data transmission in a second slot within a second time window, wherein an overlapping portion of the first time window and the second time window comprises a second quantity of soft gap slots and a second quantity of hard gap slots, and wherein the first quantity of soft gaps slots is equal to the quantity of slots the UE is capable of being scheduled for downlink data transmissions less two.

17. The UE of claim 16, wherein the one or more processors are individually or collectively further operable to execute the code to cause the UE to:
transmit an indication of the second quantity of soft gap slots, the second quantity of hard gap slots, or both.

18. The UE of claim 13, wherein the quantity of slots the UE is capable of being scheduled for downlink data transmissions equals a quantity of simultaneous active data transmissions the UE is capable of being scheduled within the time window while operating in the reduced processing operational state.

19. The UE of claim 13, wherein, to receive the one or more control messages, the one or more processors are individually or collectively further operable to execute the code to cause the UE to:
receive a first control message scheduling a first data transmission in a first slot within the first time window, wherein an active count is incremented by one for a duration associated with an active data transmission, and wherein the active count is decremented by one after the duration.

20. The UE of claim 19, wherein, to receive the one or more control messages, the one or more processors are individually or collectively further operable to execute the code to cause the UE to:
receive a second control message scheduling a second data transmission in a second slot within the first time window, wherein the active count is incremented by one for the duration associated with the active data transmission, wherein the active count is decremented by one after the duration.

21. The UE of claim 19, wherein the one or more processors are individually or collectively further operable to execute the code to cause the UE to:
transmit an indication of the active count.

22. The UE of claim 13, wherein, to receive the one or more control messages, the one or more processors are individually or collectively further operable to execute the code to cause the UE to:
receive a first control message scheduling a first data transmission in a first slot within the first time window, wherein an active count is incremented by an amount associated with an amount of time resources or frequency resources of the first slot scheduled with the first data transmission.

23. The UE of claim 13, wherein the quantity of slots the UE is capable of being scheduled for downlink data transmissions within the time window is based at least in part on a quantity of resource elements.

24. The UE of claim 13, wherein, to transmit the capability information, the one or more processors are individually or collectively further operable to execute the code to cause the UE to:
transmit an indication of a duration associated with an active data transmission.

25. A method for wireless communication by network entity, comprising:
obtaining, from a user equipment (UE), capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state;
outputting, to the UE, one or more control messages to schedule one or more data transmissions in up to the quantity of slots within a first time window in accordance with the capability information; and
outputting the one or more data transmissions within the first time window in accordance with the one or more control messages.

26. The method of claim 25, wherein outputting the one or more control messages further comprises:
outputting a first control message scheduling a first data transmission in a first slot within the first time window, wherein the first time window comprises a first quantity of soft gap slots and a first quantity of hard gap slots, wherein the one or more data transmissions are not scheduled in the hard gap slots, and wherein the one or more data transmissions are scheduled in one or more of the soft gap slots.

27. The method of claim 25, wherein the quantity of slots the UE is capable of being scheduled for downlink data transmissions equals a quantity of simultaneous active data transmissions the UE is capable of being scheduled within the time window while operating in the reduced processing operational state.

28. A method for wireless communication by user equipment (UE), comprising:
transmitting capability information that indicates a quantity of slots the UE is capable of being scheduled for downlink data transmissions within a time window while the UE is operating in a reduced processing operational state, the reduced processing operational state being associated with a first downlink data processing timeline that is different from a second downlink data processing timeline for a second processing operational state;
receiving one or more control messages to schedule one or more data transmissions in up to the quantity of slots within a first time window in accordance with the capability information; and
receiving the one or more data transmissions within the first time window in accordance with the one or more control messages.

29. The method of claim 28, wherein receiving the one or more control messages further comprises:
receiving a first control message scheduling a first data transmission in a first slot within the first time window, wherein the first time window comprises a first quantity of soft gap slots and a first quantity of hard gap slots, wherein the one or more data transmissions are not scheduled in the hard gap slots, and wherein the one or more data transmissions are scheduled in one or more of the soft gap slots.

30. The method of claim 28, wherein the quantity of slots the UE is capable of being scheduled for downlink data transmissions equals a quantity of simultaneous active data transmissions the UE is capable of being scheduled within the time window while operating in the reduced processing operational state.
